(19) United States
(12) Patent Application Publication
(10) Pub. No.: US 2026/0045475 A1
(43) Pub. Date: Feb. 12, 2026

(54) METHOD AND SYSTEM FOR CALENDARING ELECTRODE SHEETS FOR A BATTERY CELL AT AN ANGLE

(71) Applicant: GM GLOBAL TECHNOLOGY OPERATIONS LLC, Detroit, MI (US)

(72) Inventors: Joel G. TONER, Imlay City, MI (US); Nicole ELLISON, Southfield, MI (US); Bradley Allen NEWCOMB, Troy, MI (US)

(21) Appl. No.: 18/796,533

(22) Filed: Aug. 7, 2024

(51) Int. Cl. H01M 4/04

(52) U.S. Cl. CPC H01M 4/0435

(57) ABSTRACT

A method of calendaring an electrode sheet includes positioning an electrode sheet at an inlet of a calendaring system including a roller defining a calendaring axis, the electrode sheet includes an active material layer arranged on portions of a current collector, the active material layer includes a first lateral side and a second lateral side that is opposite of the first lateral side, a first uncoated portion arranged along the first lateral side of the active material layer and a second uncoated portion arranged alongside the second lateral side, the active material layer is applied along a coating axis that extends substantially parallel to the first lateral side and the second lateral side, guiding the electrode sheet into the inlet with the coating axis being angled relative to the calendaring axis, and calendaring the electrode sheet with the coating axis being at a non-zero angle relative to the calendaring axis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of battery assemblies and, more particularly, to a method and system for calendaring electrode sheets at an angle to reduce electrode wrinkling.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes and separators arranged in a battery cell stack located in a battery cell enclosure (or cell can). The cathode electrodes include a cathode active material layer arranged on a cathode current collector. The anode electrodes include an anode active material layer arranged on an anode current collector. The cathode and anode electrodes are connected to cathode and anode terminals arranged on an outer surface of the enclosure.

Battery modules or packs typically include a housing that supports the cathode terminal and the anode terminal and surrounds the battery cells. The terminals of the battery cells are connected to respective ones of the cathode electrode and the anode electrode. The battery cells are interconnected to provide a desired output voltage.

### SUMMARY

A method of calendaring an electrode sheet, in accordance with the present disclosure, includes positioning an electrode sheet at an inlet of a calendaring system including at least one roller defining a calendaring axis, the electrode sheet includes an active material layer arranged on portions of a current collector, the active material layer includes a first lateral side and a second lateral side that is opposite of the first lateral side, a first uncoated portion arranged along the first lateral side of the active material layer and a second uncoated portion arranged alongside the second lateral side, the active material layer is applied along a coating axis that extends substantially parallel to the first lateral side and the second lateral side, guiding the electrode sheet into the inlet with the coating axis being angled relative to the calendaring axis, and calendaring the electrode sheet with the coating axis being at a non-zero angle relative to the calendaring axis.

In other features, calendaring the electrode sheet with the coating axis being at the non-zero angle relative to the calendaring axis includes passing the electrode sheet through the calendaring system with the coating axis being arranged at about a 45° angle relative to the calendaring axis.

In other features, calendaring the electrode sheet with the coating axis being at the non-zero angle relative to the calendaring axis includes passing the electrode sheet through the calendaring system with the coating axis being arranged at about a 90° angle relative to the calendaring axis.

In other features, calendaring the electrode sheet with the coating axis being at the non-zero angle relative to the calendaring axis includes passing the electrode sheet through the calendaring system with the coating axis being arranged between a 25° angle and a 90° angle relative to the calendaring axis.

A system for calendaring an electrode sheet including an active material layer having a first lateral side and a second lateral side opposite of the first lateral side, a first uncoated portion arranged along the first lateral side of the active material layer and a second uncoated portion arranged alongside the second lateral side, the active material layer defining a coating axis that extends substantially parallel to the first lateral side and the second lateral side, in accordance with the present disclosure, includes a calendaring member operable to apply calendaring pressure along a calendaring axis over the electrode sheet at a non-zero angle relative to the coating axis.

In other features, an alignment system is configured to position the electrode sheet at the non-zero angle relative to the calendaring axis.

In other features, the alignment system includes a rotary table, the rotary table being configured to receive the electrode sheet in a first orientation with the coating axis substantially aligned with a travel axis of the system and rotate the electrode sheet to a second orientation with the coating axis being at the non-zero angle relative to the calendaring axis.

In other features, a cutting system is operable to cut the electrode sheet to a selected length before processing by the alignment system.

In other features, the cutting system severs the electrode sheet along a cut axis that is substantially perpendicular relative to the coating axis.

In other features, the calendaring member includes a first roller and a second roller, the first roller and the second roller moving across the electrode sheet along an axis that is at a non-zero angle relative to the coating axis.

In other features, the first roller includes a first roller axis and the second roller includes a second roller axis, the electrode sheet passing between the first roller and the second roller substantially perpendicular to the first roller axis and the second roller axis.

In other features, the first roller includes a first roller axis and the second roller includes a second roller axis, the electrode sheet passing between the first roller and the second roller substantially parallel to the first roller axis and the second roller axis.

In other features, a stationary calendaring member has a calendaring surface, the calendaring member being configured to shift across the calendaring surface along an axis that is at a non-zero angle relative to the coating axis.

In other features, a stationary calendaring member has a calendaring surface supporting the electrode sheet, the calendaring member including a plurality of rollers configured to apply calendaring pressure to the electrode sheet along an axis that is at a non-zero angle relative to the coating axis.

In other features, the plurality of rollers includes a first roller having a first roller axis, a second roller having a second roller axis, a third roller having a third roller axis, and a fourth roller having a fourth roller axis, each of the first roller axis, the second roller axis, the third roller axis, and the fourth roller axis passing through the calendaring surface.

In other features, the plurality of rollers defines a roller system having a central axis of rotation.

In other features, the first roller is configured to rotate about the first roller axis, the second roller is configured to rotated about the second roller axis, the third roller is configured to rotate about the third roller axis, the fourth roller is configured to rotate about the fourth roller axis, and the roller system is configured to rotate about the central axis of rotation.

In other features, a first direction change system arranged upstream of the calendaring member and a second direction change system arranged downstream of the calendaring member.

In other features, the first direction change system includes a first drum and the second direction change system comprises a second drum, the calendaring member being arranged between the first drum and the second drum.

In other features, a winding spool is configured to wind the electrode sheet about an axis that is substantially parallel relative to the coating axis.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram illustrating a calendaring system for calendaring electrode sheets at an angle to reduce electrode wrinkling, in accordance with the present disclosure;

FIG. 2 is a plan view of an electrode sheet positioned to be calendared at an angle in the system of FIG. 1, in accordance with the present disclosure;

FIG. 3 is a block diagram illustrating the system for calendaring electrode sheets, in accordance with an aspect of the present disclosure;

FIG. 4 is a block diagram illustrating the system for calendaring electrode sheets in accordance with another aspect of the present disclosure;

FIG. 5 is a block diagram illustrating a system for calendaring electrode sheets at an angle, in accordance with an aspect of the present disclosure;

FIG. 6 is a block diagram illustrating a system for calendaring electrode sheets at an angle, in accordance with another aspect of the present disclosure;

FIG. 7 is a block diagram illustrating a system for calendaring electrode sheets at an angle, in accordance with yet another aspect of the present disclosure;

FIG. 8 is a top view of the system for calendaring electrode sheets of FIG. 7, in accordance with the present disclosure;

FIG. 9 is a block diagram illustrating a system for calendaring electrode sheets at an angle, in accordance with the present disclosure;

FIG. 10 is a block diagram illustrating a system for calendaring electrode sheets at an angle, in accordance with still yet another aspect of the present; and

FIG. 11 is a flow diagram illustrating first direction change system and a second direction change system for the system of FIG. 10, in accordance with the present disclosure.

In the drawings, reference numbers may be reused to identify similar and/or identical elements.

### DETAILED DESCRIPTION

While battery cells formed according to the present disclosure are described in the context of electric vehicles, the battery cells can be used in stationary applications and/or other applications.

Battery cells include a plurality of electrodes each including a current collector and an active material layer coated on the current collector (e.g., a coating layer). The active material layer typically includes a mixture of active material, an optional conductive filler, and an optional binder that are mixed together and coated onto the current collector. After applying the coating layer, the electrodes pass through rollers that may be at room temperature or heated. The electrodes include cathode electrodes and anode electrodes that exchange lithium ions during charging and discharging.

During production of battery electrodes, defects can occur during calendaring. Differences in, for example, material properties of the current collector and material properties of the active material layer can lead to wrinkling of the electrode sheet. Wrinkling is particularly prevalent along border regions between the active material layer and the current collector.

More specifically, the active material layer forms an interior coated region leaving uncoated bare edges of the current collector on opposing sides of the active material. In the calendaring process, there is often a need for very high compressive force to be applied to the current collector in order to achieve higher electrode density and thereby lower electrode porosity. The very high compressive force causes wrinkling along edges of the active material layer.

The electrode calendaring systems and methods according to the present disclosure provide solutions to reduce post-calendaring wrinkling of the current collector by angling the electrode sheet entering the calendaring system. The angle may be between about 25° and 90° relative to a direction of travel of the electrode sheet during coating of the active material layer. By calendaring at an angle relative to the direction of electrode coating reduces residual stresses in the current collector and thus wrinkling is alleviated while still achieving a desired porosity.

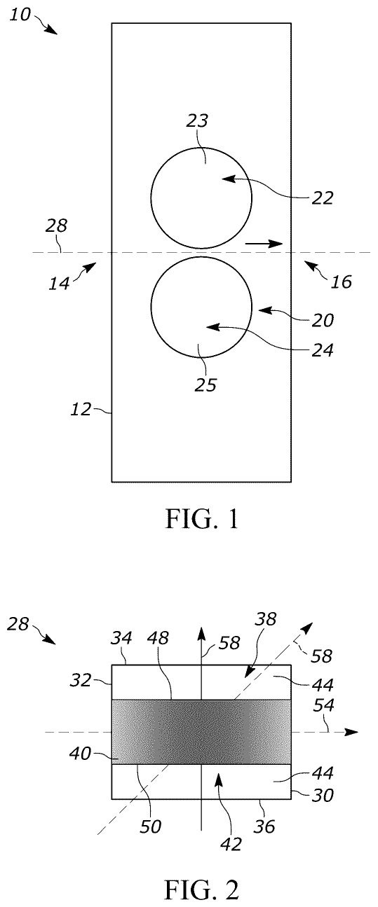

Referring now to FIG. 1, a block diagram of an exemplary calendaring system 10 is presented for reducing post-calendaring wrinkling. The calendaring system 10 of FIG. 1 and/or any of the other example systems and methods herein may be applicable in the manufacturing of battery cell electrodes (e.g., anode and cathode electrodes) for vehicle applications and/or any other suitable applications including electrodes.

As shown in FIG. 1, the calendaring system 10 includes a housing 12 having an inlet portion 14 and an outlet portion 16. A calendaring press system 20 is arranged in housing 12 between inlet portion 14 and outlet portion 16. In an example, calendaring press system 20 includes a first calendaring member 22 shown in the form of a first roller 23 and a second calendaring member 24 shown in the form of a second roller 25. While depicted as rollers, first calendaring member 22 and/or second calendaring member 24 may take on different forms as will become more fully evident herein.

Inlet portion 14 receives electrode sheet 28 and outlet portion 16 passes electrode sheet 28 from housing 12 after being calendared. Electrode sheet 28 may take on various forms including pre-cut sheets and continuous sheets. As shown in FIG. 2, electrode sheet 28 includes a first side edge 30, and opposing second side edge 32, a leading edge 34 and a trailing edge 36. In accordance with the disclosure, leading edge 34, as the name suggests, leads electrode sheet 28 into inlet portion 14. At this point, it should be understood that the term “sheet” is used to describe cut sheets having a defined length as well as continuous sheets stored on a roll.

Electrode sheet 28 includes a current collector 38 and an active material layer 40 that is coated onto portions of the current collector 38. The electrode sheet 28 can be pressed and/or heated one or more times prior to calendaring. In the example shown, electrode sheet 28 includes active material layers 42 and an unactive material layer 44. In this example, the active material layer 40 includes a first lateral side 48 that extends substantially parallel to, and is spaced from, leading edge 34 and a second lateral side 50 that extends substantially parallel to, and is spaced from, trailing edge 36. A coating axis 54 extends through active material layer 40 between first side edge 30 and second side edge 32. A calendaring axis 58 extends between leading edge 34 and trailing edge 36.

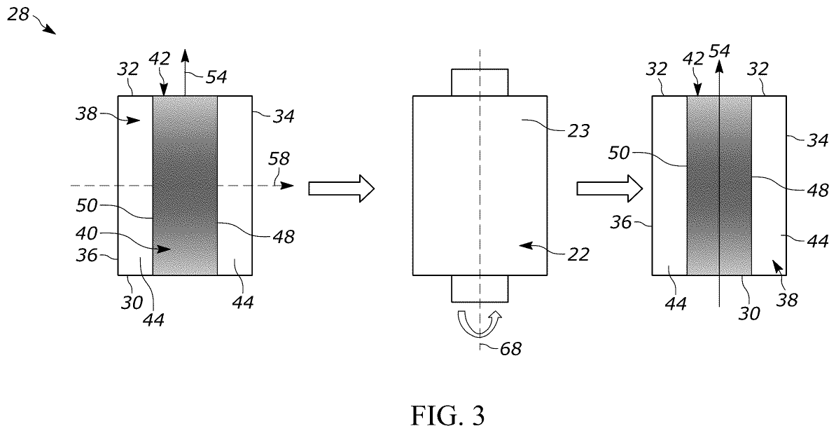

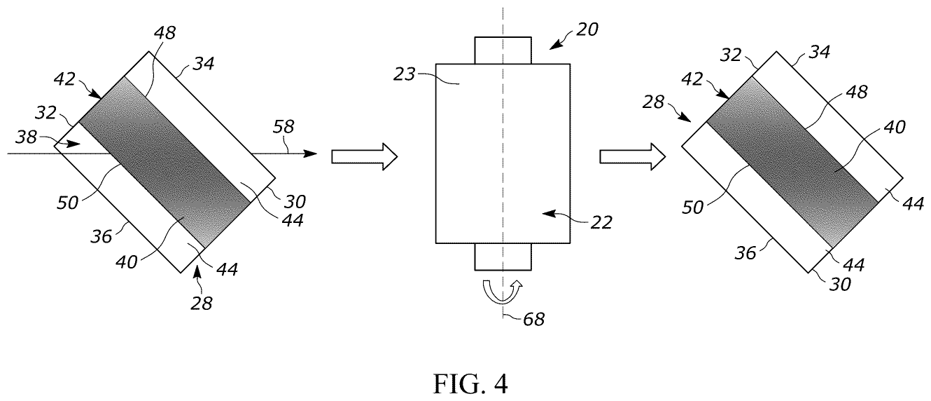

As will be detailed herein, calendaring axis 58 is different than coating axis. In other words, calendaring axis 58 forms an angle (e.g., 909 or another non-zero angle) relative to coating axis 54. For example, as shown in FIG. 3, first calendaring member 22 may have a roller axis 68 that defines an axis of rotation of first roller 23. Second calendaring member 24 includes a roller axis (not shown) that extends substantially parallel to roller axis 68. In FIG. 3, calendaring axis 58 is shown to be substantially parallel to first side edge 30 and second side edge 32 such that leading edge 34 enters calendaring press system 20 substantially parallel to roller axis 68. In FIG. 4, calendaring axis 58 is shown to be at a 45° angle relative to first side edge 30 and second side edge 32 such that leading edge 34 enters calendaring press system 20 an angle relative to roller axis 68. In accordance with the disclosure, the angle between calendaring axis 58 and roller axis 68 may be between about 25° and about 90° to reduce post-calendaring wrinkling.

In either case, coating axis 54 will pass through calendaring press system 20 either parallel to roller axis 68 (FIG. 3) or at an angle relative to roller axis 68 (FIG. 4) ensuring that unactive material layer 44 of leading edge 34 enters between first calendaring member 22 and second calendaring member 24 before active material layer 40. Guiding leading edge 34 between first calendaring member 22 and second calendaring member 24 before pressure is applied to active material layer 40, ensures that unactive material layer 44 is initially under no stress. When calendaring axis 58 is perpendicular to or angled relative to roller axis 68, stresses in active material layer 40 are uniform between first side edge 30 and second side edge 32 resulting in a decrease in wrinkling. Maintaining an angle of between about 25° and about 90° between calendaring axis 58 and roller axis 68 when calendaring electrode sheet 28 to a selected porosity value, for example 25%, produces less wrinkling than conventional methods.

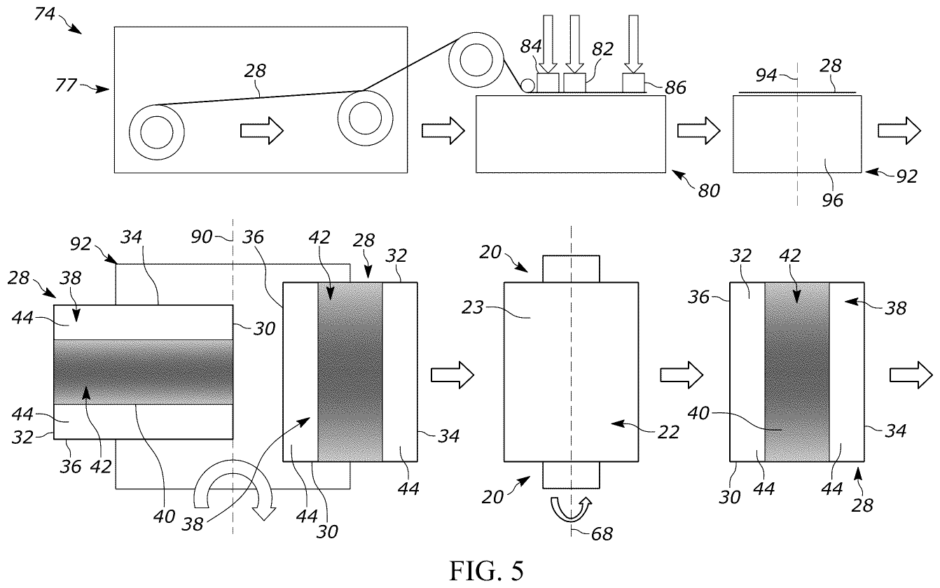

In FIG. 5 in describing a system 74 for forming electrode sheets, in accordance with the present disclosure. System 74 includes a coating system 77 that applies active material layer 40 to current collector 38. In accordance with the present disclosure, electrode sheet 28 with active material layer 40 is passed from coating system 77 to a cut and hold system 80. Cut and hold system 80 separates electrode sheet 28 into individual sheets (not separately labeled).

Cut and hold system 80 includes a cutter 82 arranged between a first clamp 84 and a second clamp 86. Electrode sheet 28 is advanced through cut and hold system 80 and first and second clamps 84/86 are activated. Once held in position, cutter 82 moves across electrode sheet along a cut axis 90. At this point, the individual electrode sheet is passed onto a rotary table 92 which spins about a table axis 94. The individual electrode sheet is then passed to calendaring press system 20 at the desired orientation positioning calendaring axis 58 positioned at the selected angle, e.g., between about 25° and about 90°, relative to roller axis 68. The individual sheet is calendared and passed from outlet portion 16 substantially wrinkle free.

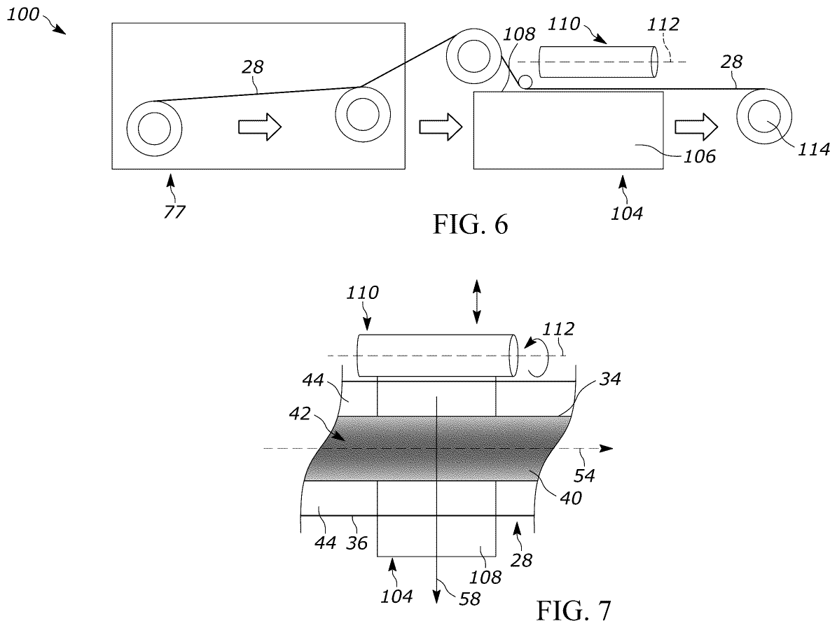

In FIG. 6 in describing a system 100 for forming electrode sheets in accordance with another aspect of the present disclosure. System 100 includes a calendaring press system 104 having a stationary calendaring member 106 including a calendaring press surface 108 and a rotatable calendaring member 110 having a roller axis 112. Electrode sheet 28 passes through coating system 77 along coating axis 54. Electrode sheet 28 then passes from coating system 77 onto calendaring press surface 108 of stationary calendaring member 106.

As shown in FIG. 7, as electrode sheet 28 moves over calendaring press surface 108 along coating axis 54 and is collected on a spool 114. As electrode sheet 28 translates over calendaring press surface 108 rotatable calendaring member 110 rotates about roller axis 112 and translates laterally across calendaring press surface 108 along calendaring axis 58. While calendaring axis 58 is shown to extend substantially perpendicularly relative to coating axis 54, rotatable calendaring member 110 may be arranged at any desired non-zero calendaring angle relative to coating axis 54.

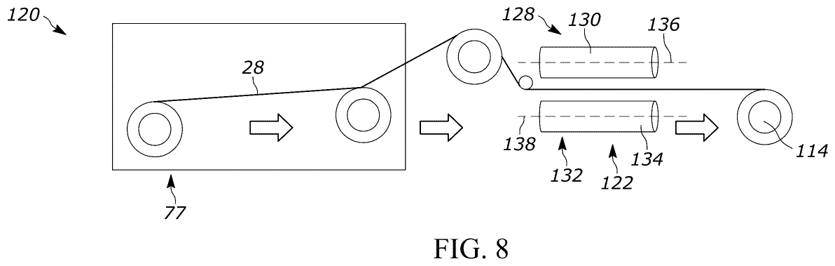

In FIG. 8, a system for forming electrode sheets 120 is shown in accordance with the present disclosure. System 120 includes a calendaring press system 122 including a first calendaring member 128 shown in the form of a first roller 130 and a second calendaring member 132 shown in the form of a second roller 134. First roller 130 includes a first roller axis 136 and second roller 134 includes a second roller axis 138. Upon exiting coating system 77, electrode sheet 28 is passed between first roller 130 and second roller 134 with coating axis 54 being substantially parallel with first roller axis 136 and second roller axis 138. In addition to rotating about respective ones of the first roller axis 136 and second roller axis 138, first roller 130 and second roller 134 translate laterally along calendaring axis 58. While calendaring axis 58 is shown to extend substantially perpendicularly relative to coating axis 54, first roller 130 and second roller 134 may be arranged at any desired non-zero calendaring angle, e.g., between about 25° and about 90°, relative to coating axis 54.

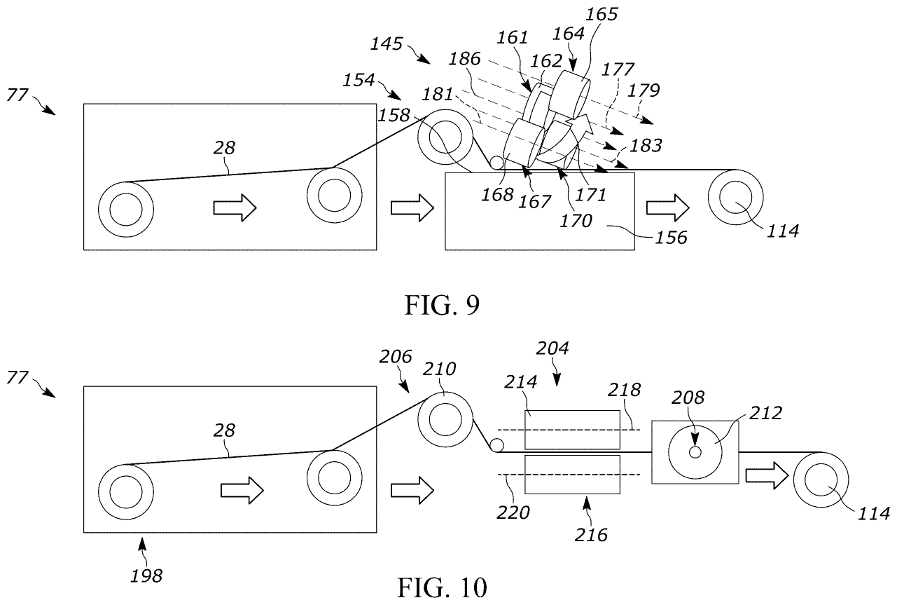

Reference will now follow to FIG. 9, wherein like numbers represent corresponding parts in the respective views, a system 145 for forming electrode sheets in accordance with the present disclosure. System 145 includes a calendaring press system 154 including a stationary calendaring member 156 having a calendaring surface 158. Calendaring press system 154 is also shown to include a first rotatable calendaring member 161 shown in the form of a first roller 162, a second rotatable calendaring member 164 shown in the form of a second roller 165, a third rotatable calendaring member 167 shown in the form of a third roller 168, and a fourth rotatable calendaring member 170 shown in the form of a fourth roller 171.

In accordance with the present disclosure, first roller 162 includes a first roller axis 177, second roller 165 includes a second roller axis 179, third roller 168 includes a third roller axis 181, and fourth roller 171 includes a fourth roller axis 183. First roller axis 177, second roller axis 179, third roller axis 181, and fourth roller axis 183 project through calendaring surface 158. In addition to rotating about each respective roller axis, first roller 162, second roller 165, third roller 168, and fourth roller 171 rotate, as a system, about a central axis of rotation 186.

Upon exiting coating system 77, electrode sheet 28 travels along coating axis 54, over calendaring surface 158. First roller 162, second roller 165, third roller 168, and fourth roller 171 rotate about corresponding ones of first roller axis 177, second roller axis 179, third roller axis 181, and fourth roller axis 183 applying pressure to electrode sheet 28 against calendaring surface 158. In addition, first roller 162, second roller 165, third roller 168, and fourth roller 171 rotate about the central axis of rotation 186. With this arrangement, calendaring axis 58 will always be at a non-zero angle relative to coating axis 54 as electrode sheet 28 passes through calendaring press system 154 resulting if few, if any, post calendaring wrinkles.

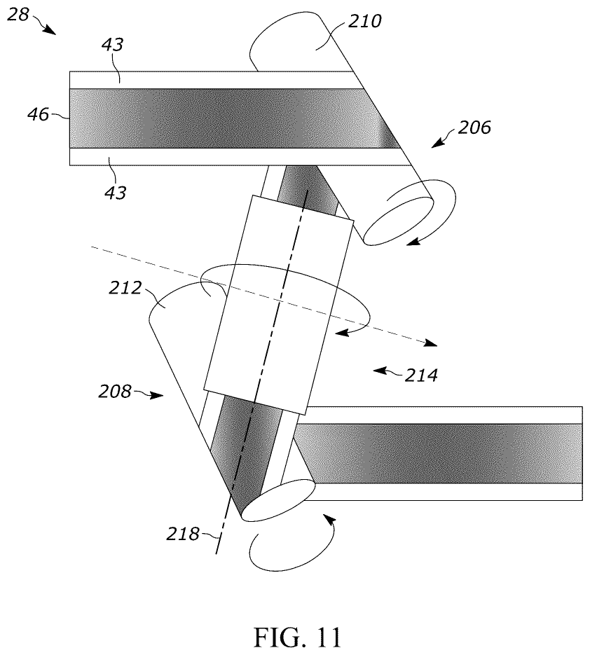

Reference will now follow to FIGS. 10 and 11, wherein like numbers represent corresponding parts in the respective views, in describing a system 198 for forming electrode sheets, in accordance with another aspect of the present disclosure. System 198 includes a calendaring press system 204 arranged between a first direction change system 206 and a second direction change system 208. First direction change system 206 may take the form of a first drum 210 and second direction change system 208 may take the form of a second drum 212. Of course, first direction change system 206 and second direction change system 208 may take on various forms including spools, rollers, and the like.

Calendaring press system 204 includes a first rotatable calendaring member 214 and a second rotatable calendaring member 216. First rotatable calendaring member 214 includes a first roller axis 218 and second rotatable calendaring member 216 includes a second roller axis 220. As shown in FIG. 11, first direction change system 206 forces electrode sheet 28 to pass between first rotatable calendaring member 214 and second rotatable calendaring member 216 such that coating axis is substantially parallel to each of the first roller axis 218 and the second roller axis 220.

As electrode sheet 28 passes through calendaring press system 204, in addition to rotating, first rotatable calendaring member 214 and second rotatable calendaring member 216 travel laterally. In this manner, calendaring axis 58 is substantially perpendicular relative to coating axis 54. With this arrangement, calendaring axis 58 will always be at a non-zero angle relative to coating axis 54 as electrode sheet 28 passes through calendaring press system 154 resulting if few, if any, post calendaring wrinkles.

The terms “about” and “substantially” are intended to include the degree of error associated with measurement of the particular quantity based upon the equipment available at the time of filing the application. For example, “about” and “substantially” can include a range of ±8% of a given value.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method of calendaring an electrode sheet comprising:
positioning an electrode sheet at an inlet of a calendaring system including at least one roller defining a calendaring axis, the electrode sheet includes an active material layer arranged on portions of a current collector, the active material layer includes a first lateral side and a second lateral side that is opposite of the first lateral side, a first uncoated portion arranged along the first lateral side of the active material layer and a second uncoated portion arranged alongside the second lateral side, the active material layer is applied along a coating axis that extends substantially parallel to the first lateral side and the second lateral side;
guiding the electrode sheet into the inlet with the coating axis being angled relative to the calendaring axis; and
calendaring the electrode sheet with the coating axis being at a non-zero angle relative to the calendaring axis.

2. The method of claim 1, wherein calendaring the electrode sheet with the coating axis being at the non-zero angle relative to the calendaring axis includes passing the electrode sheet through the calendaring system with the coating axis being arranged at about a 45° angle relative to the calendaring axis.

3. The method of claim 1, wherein calendaring the electrode sheet with the coating axis being at the non-zero angle relative to the calendaring axis includes passing the electrode sheet through the calendaring system with the coating axis being arranged at about a 90° angle relative to the calendaring axis.

4. The method of claim 1, wherein calendaring the electrode sheet with the coating axis being at the non-zero angle relative to the calendaring axis includes passing the electrode sheet through the calendaring system with the coating axis being arranged between a 25° angle and a 90° angle relative to the calendaring axis.

5. A system for calendaring an electrode sheet including an active material layer having a first lateral side and a second lateral side opposite of the first lateral side, a first uncoated portion arranged along the first lateral side of the active material layer and a second uncoated portion arranged alongside the second lateral side, the active material layer defining a coating axis that extends substantially parallel to the first lateral side and the second lateral side, the system comprising:
a calendaring member operable to apply calendaring pressure along a calendaring axis over the electrode sheet at a non-zero angle relative to the coating axis.

6. The system according to claim 5, further comprising: an alignment system configured to position the electrode sheet at the non-zero angle relative to the calendaring axis.

7. The system according to claim 6, wherein the alignment system includes a rotary table, the rotary table being configured to receive the electrode sheet in a first orientation with the coating axis substantially aligned with a travel axis of the system and rotate the electrode sheet to a second orientation with the coating axis being at the non-zero angle relative to the calendaring axis.

8. The system according to claim 7, further comprising: a cutting system operable to cut the electrode sheet to a selected length before processing by the alignment system.

9. The system according to claim 8, wherein the cutting system severs the electrode sheet along a cut axis that is substantially perpendicular relative to the coating axis.

10. The system according to claim 5, wherein the calendaring member includes a first roller and a second roller, the first roller and the second roller moving across the electrode sheet along an axis that is at a non-zero angle relative to the coating axis.

11. The system according to claim 10, wherein the first roller includes a first roller axis and the second roller includes a second roller axis, the electrode sheet passing between the first roller and the second roller substantially perpendicular to the first roller axis and the second roller axis.

12. The system according to claim 11, wherein the first roller includes a first roller axis and the second roller includes a second roller axis, the electrode sheet passing between the first roller and the second roller substantially parallel to the first roller axis and the second roller axis.

13. The system according to claim 5, further comprising: a stationary calendaring member having a calendaring surface, the calendaring member being configured to shift across the calendaring surface along an axis that is at a non-zero angle relative to the coating axis.

14. The system according to claim 5, further comprising: a stationary calendaring member having a calendaring surface supporting the electrode sheet, the calendaring member including a plurality of rollers configured to apply calendaring pressure to the electrode sheet along an axis that is at a non-zero angle relative to the coating axis.

15. The system according to claim 14, wherein the plurality of rollers includes a first roller having a first roller axis, a second roller having a second roller axis, a third roller having a third roller axis, and a fourth roller having a fourth roller axis, each of the first roller axis, the second roller axis, the third roller axis, and the fourth roller axis passing through the calendaring surface.

16. The system according to claim 15, wherein the plurality of rollers defines a roller system having a central axis of rotation.

17. The system according to claim 16, wherein the first roller is configured to rotate about the first roller axis, the second roller is configured to rotated about the second roller axis, the third roller is configured to rotate about the third roller axis, the fourth roller is configured to rotate about the fourth roller axis, and the roller system is configured to rotate about the central axis of rotation.

18. The system according to claim 5, a first direction change system arranged upstream of the calendaring member and a second direction change system arranged downstream of the calendaring member.

19. The system according to claim 18, wherein the first direction change system includes a first drum and the second direction change system comprises a second drum, the calendaring member being arranged between the first drum and the second drum.

20. The system according to claim 5, further comprising: a winding spool configured to wind the electrode sheet about an axis that is substantially parallel relative to the coating axis.
